(19) United States
(12) Patent Application Publication
(10) Pub. No.: US 2005/0032236 A1
(43) Pub. Date: Feb. 10, 2005

(54) Graphite anchor targets

(76) Inventor: Jan Axelsson, Akademiska sjukhuset (SE)

Correspondence Address: AMERSHAM BIOSCIENCES;PATENT DEPARTMENT, 800 CENTENNIAL AVENUE, PISCATAWAY, NJ, 08855, US

(21) Appl. No.: 10/496,849

(22) PCT Filed: Nov. 28, 2002
(86) PCT No.: PCT/EP02/13407

(30) Foreign Application Priority Data
Nov. 29, 2001 (GB) 0128586.5

(51) Int. Cl. G01N 24/00

(52) U.S. Cl. 436/173; 422/58

(57) ABSTRACT

The present invention relates to a method of treating MALDI target slides (1), and slides after such treatment, in which droplets of a suspension of graphite particle are applied to the target surface (4) of a target slide (1) and allowed to evaporate. The resulting spots (2) left on the target surface contain homogeneously distributed graphite particles (3).

### FIELD OF THE INVENTION

The present invention relates to mass spectrometry target slides devices, and methods for preparing such slides, of the types mentioned in the preambles of the independent claims.

### PRIOR ART

Matrix-assisted laser desorption/ionisation (MALDI) mass spectrometry is a method in which a crystallised matrix made of light-absorbing small molecules is excited by a short laser pulse that creates vibrational movement of the matrix molecules. This movement releases some of the matrix molecules at the surface, and embedded analyte molecules are also dragged out into the surrounding vacuum of the ion source. At some point during this process, a fraction of the analyte and matrix molecules gets singly ionised, and this fraction of molecules are accelerated out of the ion source for mass-to-charge ratio (M/Z) analysis, often in a time-of-flight (TOF) system.

Before being examined by MALDI mass spectroscopy the analyte being tested has to be prepared so that it is in a suitable form for MALDI mass spectroscopy. Typically it is prepared in the following way:
the analyte is added to a solution of laser light absorbing matrix;
droplets of the analyte/matrix mixture are then placed on a MALDI target slide; and, the solvent allowed to evaporate leaving crystals of sample/matrix on the target slide.

Problems that commonly occur with this method are non-uniform crystal size, and a non-uniform distribution of crystals on the surface. For example, when using alpha-cyano-4-hydroxycinnamic acid (ACCA) there is often crystallisation around the perimeter of the applied sample spot leaving a central void or area poor in crystals, and when using 2,5-dihydroxybenzoic acid (DHB) large needle-like crystals stacked randomly over the target slide surface are often formed. For both matrices the result is that large areas give very little or no signal. This leads to poor signal reproducibility. Thus, the mass spectrometer (or the operator) needs to search for areas that give good signal, which is often done by using a camera-equipped mass spectrometer to visually locate crystal, or by just looking at the spectral quality of the mass spectrometer signal while moving the sample around. Neither method is entirely satisfactory as the first method requires the cost of the camera and the use of an operator to look for the sample spot while the second method may also require an operator and is time-consuming.

A better solution to the problem would be to produce sample spots containing a substantially uniform distribution of crystals. Attempts to achieve this have been made by, for example, providing hydrophilic anchors surrounded by hydrophobic surfaces. The droplets are placed on the hydrophilic anchors and the hydrophobic surrounding surface prevents the droplets from moving from the anchors as the solvent evaporates. This causes the crystals to form on a well-defined area. Additionally the matrix concentration can be adjusted to ensure that when the solvent has evaporated the matrix material from the droplet is sufficient to cover the area with a layer of crystals. However this method cannot guarantee that crystallisation does not occur only around the rim of the area or that large needle-like crystals are not produced.

### SUMMARY OF THE INVENTION

According to the present invention, at least some of the problems with the prior art are solved by means of a method having the features present in the characterising part of claim 1, a method having the features of claim 8, and a device having the features mentioned in the characterising part of claim 9.

### BRIEF DESCRIPTION OF THE FIGURES

FIG. 1a) shows images of ACCA, normal dried-droplet sample preparation;

FIG. 1b) shows images of ACCA samples pre-treated with graphite suspension in water,

FIG. 2a) shows the signal intensity distribution in arbitrary units for dried-droplet prepared ACCA samples on a prior art slide;

FIG. 2b) shows the signal intensity distribution in the same arbitrary units for dried-droplet prepared ACCA samples on a slide pre-treated with graphite suspension in water,

FIG. 3a) shows a view from above of a target slide in accordance with the present invention: and,

FIG. 3b) shows a side view of the slide of FIG. 3a).

### DETAILED DESCRIPTION OF EMBODIMENT ILLUSTRATING THE INVENTION

A method of pre-treating mass spectroscopy target slides for improving the distribution of matrix crystals on such target slides in accordance with a first embodiment of the present invention, comprises the following steps;
a) before application of an analyte, a target slide 1 is pre-treated by droplets 2 of a suspension of graphite particles 3 in a liquid being applied at spaced intervals to the target surface 4 of the target slide; and,
b) the liquid is allowed or forced (e.g. by heating or blowing air over the droplet) to evaporate so that these droplets of suspension are allowed to dry thereby leaving spots of graphite particles on the target slide.

The liquid used in the suspension can be any suitable liquid. To be suitable for the present invention, it should preferably fulfil the following requirements:
a) it should be volatile enough (i.e. readily vaporizable at a relatively low temperature) to evaporate quickly enough in a normal laboratory environment so that the minimum amount of time is spent waiting for it to evaporate, while at the same time it should not evaporate too quickly. This is because the suspension defines the deposition area by the area covered by the droplet. Under the influence of gravity, the graphite particles fall to the target surface. If the liquid solutions evaporates too quickly then it may evaporate faster than the fall rate due to gravity, which causes fluidic motion at a rate which may cause disturbed homogeneity, e.g. the graphite particles may collect in the centre of the target area instead of being spaced homogeneously over its deposition area. Preferably a droplet containing a volume of 1 μl of graphite suspended in liquid should dry in a time period of between 5 seconds and 1 day, but most preferably in a time period of between 10 seconds and 1 hour. The choice of liquid is therefore depend on the ambient conditions and can be optimised; and,
b) if the liquid wets the surface too well then it will spread further than a liquid which wets the surface less well. Water wets a stainless steel surface less well than methanol and, as the results below show, water gives a more homogeneous target. The choice of a suitable liquid is dependent on the material and surface finish of the surface to which is it to be applied as well as the surface tension of the liquid when on such a surface.

Examples of suitable liquids are water, methanol, ethanol, acetonitrile, etc, and combinations thereof.

The suspension of graphite particles can be made by adding particles to a container containing the liquid, for example by adding a quantity of particles to a test tube containing the liquid.

Alternatively, the suspension could be made by adding the particles to drops of liquid on a surface. For example, one or more droplets of liquid could be applied to a target slide and then particles could be applied by placing the slide in a particle chamber in which graphite particles are being blown around. Some of the particles would enter the droplets and after a period of time had elapsed the slide could be removed from the particle chamber, unwanted particles that had settled on the target slide outside the droplets removed by, preferably gentle, blowing or suction or washing or polishing or the like, or not removed at all. The droplets could then be allowed to evaporate, leaving areas containing particles.

As another alternative, a slide could be pre-treated by an adhesive or tacky substance being applied to areas on its surface. These areas of the slide could then be coated by particles, for example by particles being dropped onto the surface or by being placed in a particle chamber in which particles are being blown around. Excess particles could be removed by blowing or suction.

When a target slide pre-treated in accordance with the present invention is to be used to analyse an analyte, a droplet of, preferably saturated, matrix solution containing the analyte to be tested is applied to each of the spots of graphite particles on the target slide and the solvent allowed or forced to evaporate. The target slide is then ready for analysis and can be placed in a mass spectroscope and analysed in the usual manner.

Experimental Procedure

Experiments to illustrate the improvements obtained by a method in accordance with the present invention were performed as described below. Peptides and powder chemicals were purchased from Sigma Aldrich. Solvents were standard solvents available from most laboratory supply companies. Sample target slides were Ettan standard stainless steel target slides (Ettan stainless steel MALDI target slide from Amersham Biosciences, Uppsala, Sweden). These target slides contain one row of target areas upon which samples are intended to be deposited.

Experiments were performed using an Ettan MALDI mass spectrometer (from Amersham Biosciences AB, Sweden).

Suspensions of 1-2 μm graphite particles (Sigma Aldrich 28-286-3) were prepared at concentrations of approximately 2 mg/ml. Two suspensions were tried, the first with graphite suspended in methanol, the second with graphite suspended in water.

A saturated matrix solution containing α-Cyano-4-Hydroxy-Cinnamic acid (ACCA) and 4 pmol/μl Angiotensin III (M/Z=897) was prepared in 50% acetonitrile 50% water and 1% TFA.

A 10 mg/ml matrix solution containing 2,5-Dihydroxybenzoic acid (DHB) and 200 fmol/l of Bradykinin (M/Z=1060), Angiotensin (M/Z=1297) and Neurotensin (M/Z=1673) was prepared in 1 part ethanol and 9 parts 0.1% TFA in water.

One MALDI target slide was pre-treated with C₆₀ (Buckminister fullerene) solution (which is only soluble in some very non-polar solvents). It was cleaned with alcohol and wiped.

One third of the target spots on a target slide were pre-treated by applying 1 μl of the graphite in methanol suspensions (after shaking) and letting the droplets dry. One third of the target spots on a target slide were pre-treated by applying 1 μl of the graphite in water suspensions (after shaking) and letting the droplets dry. The methanol solution dried quickly, and the water solution took about an hour for the water to evaporate at room temperature. The remaining clean target spots on the slide were left untreated to act as controls.

Half of each of the water solution pre-treated, methanol solution pre-treated and untreated target spots had 0.5 μl of the solution of sample and matrix deposited on then, the remaining target spots had 1.0 μl of the solution deposited on them. The solvent was allowed to evaporate and the target spots analysed in a mass spectrometer.

The ACCA matrix samples were analysed on single positions, and the DHB samples were analysed by scanning the full length of the slide using then-layer chromatography mode. These experiments were performed on an APB Ettan MALDI mass spectrometer.

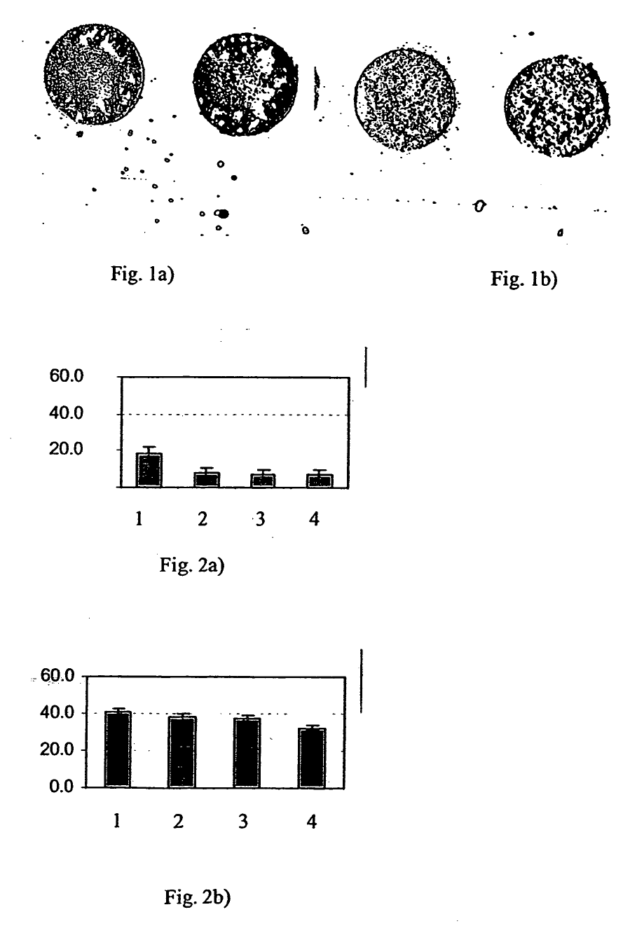

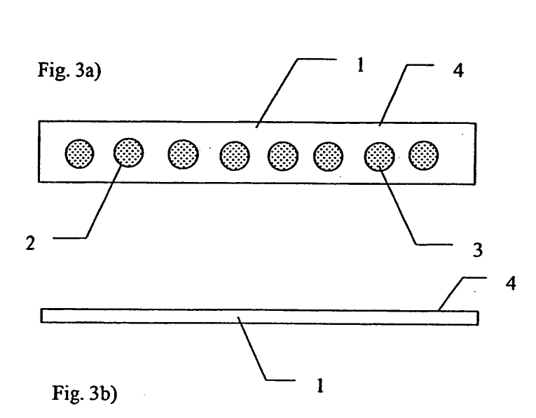

A Bruker Biflex III using 100 shots per averaged spectrum was used for level of detection comparative studies between normal stainless steel, and graphite pre-treated target slides. Excerpts of the results of the experiment are shown in FIGS. 1a), 1b), 2a), 2b).

All targets were photographed with light shining parallel to the target slide. This made the crystals light up. FIGS. 1a) and 1b) have had the black colour removed electronically to improve understanding of the images.

Results confirm that ring-shaped crystallisation occurs with normal sample deposition on untreated stainless steel targets, whereas graphite pre-treated targets displayed a more homogeneous crystal distribution. It was found that a water suspension of the graphite dried into a more controlled spot, whereas the methanol suspension tended to float outside the spot. The results show that the graphite treated samples gave a signal over the whole sample spot, whereas the non-treated stainless steel targets gave less signal strength (possibly due to the inhomogeneous crystal distribution) and less consistent data from different positions. The observation that C₆₀ signal was seen in the positions where no analyte signal was observed, and vice versa, further strengthens the argument that the absence of a of signal is due to exposing the stainless steel (which was covered by C₆₀).

While the above embodiments of the present invention show the use of carbon particles, it is also conceivable to use other suitable particles, namely particles that are less than 50 μm across, preferably less than 10 μm across and most preferably less than 2 μm across, that are inert to the matrix/sample solution, that have a mass or fragment mass easily distinguished from samples used in the mass spectroscopy and which preferably do not form fragments when ionised by a laser. The concentrations of particle in the suspending fluid can be any concentration which allows the particle to be dispensed. The concentration depends on the particle material and size, and the fluid that it is suspended in. Preferably the concentration is sufficiently low so that the fluid is fluid enough to be easily applied while at the same time being sufficiently high that the time for the fluid to evaporate is kept short and that the layer of particles remaining after the fluid has evaporated is forms a dense pattern without appreciable voids. Most preferably the layer of particles remaining after the fluid has evaporated is one particle deep. The concentration necessary to achieve this can be determined experimentally, for example by applying different concentrations of particle suspensions to a target slide, allowing the suspending fluid to evaporate and inspecting the resulting spots to determine which concentration gives the best coverage.

The above mentioned embodiments are merely intended to illustrate the present invention and are not intended to limit the scope of protection claimed by the following claims.

1. A method of pre-treating a mass spectroscopy target slide, before application of a sample, comprising the following steps:
a) applying to the target surface of the target slide one or more droplets of a suspension of graphite particles; and,
b) allowing said one or more droplets to dry leaving one or more spots containing graphite particles on the target slide.

2. The method of claim 1, wherein said suspension of graphite particles contains graphite particles at a concentration of approximately 2 mg/ml.

3. The method of claim 1, wherein the graphite particles have a maximum dimension of less than 2 μm.

4. The method of claim 1, wherein said suspension contains water.

5. The method of claim 1, wherein said suspension contains a volatile liquid.

6. The method of claim 5, wherein said liquid is an alcohol or organic solvent or inorganic solvent.

7. The method of claim 1, wherein each of said spots contain graphite particles distributed homogeneously over the spot.

8. A method of preparing a sample for MALDI analysis comprising the steps of:
pre-treating a target slide with the method of claim 1;
applying a droplet of matrix solution containing said sample to said spot resp. spots on said target slide; and
allowing said matrix and sample solution to dry.

9. A target slide for use in a mass spectrometer wherein target areas containing graphite particles.

10. The target slide of claim 9, wherein said slide is made of metal.
